(19) United States
(12) Patent Application Publication
(10) Pub. No.: US 2006/0090646 A1
(43) Pub. Date: May 4, 2006

(54) Adsorbent material for selective adsorption of carbon monoxide and unsaturated hydrocarbons

(75) Inventors: James A. Sawada, Vancouver (CA); Soheil Alizadeh-Khiavi, Burnaby (CA)

Correspondence Address: KLARQUIST SPARKMAN, LLP, 121 SW SALMON STREET, SUITE 1600, PORTLAND, OR, 97204, US

(73) Assignee: QuestAir Technologies Inc.

(21) Appl. No.: 11/268,263

(22) Filed: Nov. 3, 2005

Related U.S. Application Data
(60) Provisional application No. 60/625,371, filed on Nov. 4, 2004.

(51) Int. Cl. B01D 53/02

(52) U.S. Cl. 95/140; 96/108

(57) ABSTRACT

An improved adsorbent material is provided which is adsorptively selective for carbon monoxide and/or unsaturated hydrocarbon gases in the presence of other gas components. In an exemplary embodiment, the improved adsorbent provides a desirably large adsorptive working capacity for carbon monoxide and/or unsaturated hydrocarbons at elevated partial pressures of such gases, such as above about 0.2 bar. Such improved adsorbent is particularly suited for intensive cyclic adsorption separation processes, to selectively adsorb and desorb carbon monoxide and/or unsaturated hydrocarbons, having an adsorptive working capacity of at least about 0.6 mmol/g·bar at partial pressures above about 0.2 bar, as measured for adsorption of carbon monoxide at about 70° C.

### CROSS REFERENCE TO RELATED APPLICATIONS

This application claims the benefit of the earlier filing date of Sawada et al., U.S. Provisional Application No. 60/625,371, entitled “Improved Adsorbent Material For Selective Adsorption Of Carbon Monoxide and Unsaturated Hydrocarbons,” filed Nov. 4, 2004, which is incorporated herein by reference.

### FIELD

The present disclosure relates to adsorbent materials, particularly improved adsorbent materials suited for adsorption of carbon monoxide and unsaturated hydrocarbons.

### BACKGROUND

Adsorbent materials are known in the art as capable of adsorbing different gases and vapors. The ability of some adsorbent materials to selectively adsorb some compounds more strongly than others has been widely applied, industrially, to enable separation of gas streams into multiple constituent components. Particularly, pressure swing, temperature swing, and partial pressure swing adsorption processes have been developed that take advantage of the selective adsorption properties of different adsorbent materials and enable commercially significant separations of mixed gases.

Such commercially valuable separations include the adsorption of carbon monoxide and/or unsaturated hydrocarbons from a feed stream containing a carbon monoxide and/or unsaturated hydrocarbon component. Carbon monoxide is an important industrial gas species, as either a desired product gas or as an undesired contaminant gas, depending upon the application. In the first case it is desirable to concentrate the carbon monoxide and increase its purity, while the latter applications generally seek to minimize the concentration of the carbon monoxide in the product stream. Similarly, unsaturated hydrocarbon gases also are commercially important, particularly in the energy and petrochemical industries, and may be desired products, or undesired contaminants, and therefore desirably separated from other gas components.

Several intrinsic adsorption-related properties are desirable for an adsorbent material to be efficient for a particular adsorptive separation process. The adsorbent material should have a sufficiently large adsorptive capacity for the target gas component to be useful for adsorptive separation of that component. A useful measure of the adsorption capacity of a particular adsorbent is the material's “working capacity,” which is defined as the amount of target gas the adsorbent can adsorb over a selected partial pressure range for that target gas. Second, the adsorbent material preferably has a relatively non-rectangular adsorption isotherm, over the partial pressure range of interest, i.e., the adsorbents capacity for the target gas has a relatively linear relationship with the partial pressure of that gas. The slope of the isotherm described should, in the region of interest, provide a suitable working capacity for the target gas. Such non-rectangular adsorption isotherms are characteristic of adsorbent materials that demonstrate a desirably large working capacity to allow for cyclic adsorption and desorption of useful amounts of the adsorbed gas component over the pressure, temperature or partial pressure range available for performing the adsorptive separation process.

Adsorbent materials have been disclosed that are capable of preferential adsorption of carbon monoxide and/or unsaturated hydrocarbon gases to separate them from other gas components in a gas mixture. However, such known carbon monoxide and/or unsaturated hydrocarbon adsorbent materials are limited in their usefulness for intensive cyclic adsorption applications such as pressure, temperature or partial pressure swing adsorption, due to their undesirably low adsorptive capacity, particularly adsorptive working capacity at elevated partial pressures of carbon monoxide, which decreases the efficiency of the materials for such separations.

### SUMMARY

According to an embodiment of the present invention, an improved adsorbent material is disclosed that is adsorptively selective for carbon monoxide and/or unsaturated hydrocarbon gases in the presence of other gas components, which may include, by way of example and without limitation, carbon dioxide, hydrogen, nitrogen, or other gases or vapors. In a first embodiment, the present inventive improved adsorbent material provides a desirably large adsorptive working capacity for carbon monoxide and/or unsaturated hydrocarbons at elevated partial pressures of such gases, such as above about 0.2 bar. For intensive cyclic adsorption separation processes, such as rapid cycle pressure, temperature, or partial pressure swing adsorption to selectively adsorb and desorb carbon monoxide and/or unsaturated hydrocarbons, the desirable working capacity of the inventive adsorbent material typically is at least about 0.6 mmol/g·bar at partial pressures above about 0.2 bar, as measured for adsorption of carbon monoxide at about 70° C.

In a further embodiment of the inventive improved adsorbent material, the working capacity is at least about 0.75 mmol/g-bar at partial pressures above about 0.2 bar, as measured for adsorption of carbon monoxide at about 70° C.

In a particular embodiment, the inventive adsorbent material may contain a suitable active component, typically a metal, semimetal, or metal alloy compound, and most typically a metal component, such as copper, silver, or tin. Disclosed embodiments of the adsorbent material also may include a compound or composition comprising a suitable active compound, such as a metal halide compound). The active component may be deposited and dispersed on a support, such as an activated carbon support. Depositing the active component may be accomplished by any suitable method now known or hereafter developed, such as aqueous impregnation or by solid-state or vapour-phase techniques. In an exemplary embodiment, the active compounds containing the active metal component may include Cu(I) salts, such as a copper halide, exemplified by CuCl, silver salts, such as AgNO₃, oxides of tin, or combinations thereof. The inventive adsorbent material resulting from the combination of the active compound with an activated support typically has an adsorptive working capacity of at least about 0.6 mmol/g·bar at partial pressures above about 0.2 bar, as measured for adsorption of carbon monoxide at about 70° C. In a particular embodiment of the present inventive adsorbent material, the adsorptive working capacity may be at least about 0.75 mmol/g·bar at partial pressures above about 0.2 bar, as measured for adsorption of carbon monoxide at about 70° C.

Disclosed embodiments of adsorbent materials may be produced by any suitable method now known or hereafter developed. For example, with reference to copper-containing adsorbents, solid-state thermal dispersion of an active component, such as a copper halide, on a support, such as an activated carbon adsorbent support, may be used. A suitable embodiment of an adsorbent material according to the present invention may be produced by a process comprising intimately and substantially evenly mixing a suitable quantity of a suitable active component, such as a copper metal halide powder, with a finely powdered activated support, such as carbon adsorbent, and heating the mixture at a temperature and for a time which is sufficient to substantially evenly disperse the copper halide on the activated carbon powder to form an improved adsorbent material according to the present invention. Exemplary processes for the thermal dispersion of active metal compounds on adsorbent material supports such as may be adapted for the production of an embodiment of the present inventive adsorbent material are disclosed in U.S. Pat. No. 4,917,711 to Xie et al., which is incorporated herein by reference.

In a further embodiment of the present invention, disclosed adsorbent materials such as adsorbent materials comprising a copper metal halide dispersed on an activated carbon powder, may be subsequently formed into adsorbent particles or sheets, suitable for use in adsorptive separation applications, particularly intensive cyclic adsorptive separation applications, which may include rapid cycle temperature, pressure or partial pressure swing adsorption. Alternatively, sheets, cloth, mesh, fabric, pellets, beads, or extrudates of activated support material, such as activated carbon, may be formed and subsequently impregnated with an active component, such as the copper metal halide, to form the improved inventive adsorbent material. Exemplary suitable sheets of the present inventive adsorbent material may be produced by applying an aqueous slurry comprising the inventive adsorbent material to any suitable support material, such as is disclosed in assignee's copending published U.S. patent application Ser. No. 10/041,536, the contents of which are hereby incorporated by reference. Alternatively, suitable sheets of a precursor adsorbent material may be produced such as by the methods disclosed in the above referenced patent application, after which a suitable copper metal halide material may be dispersed on the adsorbent material sheet to result in a suitable sheet comprising the present inventive adsorbent material.

In an embodiment according to the present invention where aqueous solutions of Cu(II) halides are used to impregnate a suitable adsorbent material, a chemical reduction step is used to generate a Cu(I) salt active for selective adsorption of carbon monoxide and/or unsaturated hydrocarbons. In a further embodiment of the present invention, Cu(I) halide compounds may be introduced directly into and onto a suitable adsorbent material, such as activated carbon, by dissolving a suitable Cu(I) salt in a solvent, such as concentrated acid (typically a mineral acid, such as hydrochloric acid) or in aqueous ammonia. A formed adsorbent (such as comprising activated carbon) particle, sheet or fabric/cloth is impregnated with the active metal solution, thereby mitigating the need for any subsequent chemical reduction treatments. Multiple impregnation treatments may be used to increase the adsorbent material loading in certain embodiments.

### DETAILED DESCRIPTION

An improved adsorbent material adsorptively selective for carbon monoxide and/or unsaturated hydrocarbon gases according to an embodiment of the present invention may be produced by the deposition of a suitable active metal or metal alloy, or compound or composition comprising the active metal or metal alloy, such as copper halide compound, on the surface and preferably also within the pores of an activated support, such as an activated carbon adsorbent. Suitable activated carbon adsorbent materials may preferably have high specific surface areas of from at least about 600 m²/g to at least about 1000 m²/g, which may be greater than other potentially suitable known but less preferred adsorbent materials, potentially including alumina-, silica-, or zeolite-based materials. Carbon monoxide and/or unsaturated hydrocarbon-selective adsorbent materials prepared by the deposition of copper halides on such known, less preferred materials have been found in some previous tests to result in undesirably low adsorptive working capacities of less than about 0.6 mmol/g·bar at partial pressures above about 0.2 bar, as measured for adsorption of carbon monoxide at about 70° C. A desirable and distinguishing property of the improved adsorbent material according to the present invention is its high adsorptive working capacity for carbon monoxide and/or unsaturated hydrocarbons of at least about 0.6 mmol/g·bar, and more preferably, at least about 0.75 mmol/g·bar at elevated partial pressures above about 0.2 bar (as measured for adsorption of carbon monoxide at about 70° C.).

Activated carbon materials suitable for producing an improved adsorbent material according to a disclosed embodiment of the invention may be selected from any suitable porous activated carbon designed for adsorption of targeted components in either the gas or liquid phase. The adsorptive characteristics of the selected activated carbon may then be modified by depositing a suitable active metal compound, such as copper halide, onto the surface of the adsorbent. As the content of metal compound (such as copper halide) is increased, the surface of the support is increasingly masked. Hence, the adsorptive characteristics of the support material, such as carbon, may be progressively altered. Whereas the original unadulterated activated carbon material may have a relatively high CO₂ adsorption capacity and a lower CO adsorption capacity (as measured at equal temperature and partial pressure), the impregnation of the copper halide may act to decrease the CO₂ adsorption capacity of the adsorbent while effectively increasing the CO adsorption capacity (as compared to the original unadulterated activated carbon). This adsorptive selectivity inversion may act as a progressive continuum as active component loading, such as copper halide loading, on the activated adsorbent material increases. For example, and with reference to copper halide material on an activated carbon support, loading may increase until a point where the CO₂ adsorptive capacity of the copper halide impregnated carbon adsorbent may be much lower than the CO capacity of the copper halide impregnated carbon adsorbent.

In an exemplary embodiment, an inventive improved copper halide impregnated carbon adsorbent material may be applied to selectively adsorb carbon monoxide and additional gas species from a hydrogen-containing feed gas stream (such as a reformate stream), where such additional gas (or vapor) species to be adsorbed along with carbon monoxide may include, for example, carbon dioxide, nitrogen, methane, and water. The relative quantities of carbon monoxide (and/or unsaturated hydrocarbons) and additional gas species to be adsorbed may be advantageously controlled by the appropriate selection of the original precursor activated carbon adsorbent material and by tailoring the degree of copper halide loading onto the precursor carbon adsorbent material during copper halide dispersion.

In addition to their suitability for adsorbing other gas species in addition to carbon monoxide and/or unsaturated hydrocarbons, such as other gas species constituent in a feed gas stream, precursor activated carbon adsorbent materials suited for producing the improved inventive selective adsorbent may preferably be chosen from those activated carbon adsorbent materials having average pore diameters ranging between from about 7 to about 550 Angstroms, and more typically between from about 10 to about 100 Angstroms.

Active metal compounds, such as metal halide compounds suitable for dispersion on a suitable precursor adsorbent material, such as an activated carbon adsorbent, to produce an improved adsorbent material selective for carbon monoxide and/or unsaturated hydrocarbons according to an embodiment of the present invention may be selected from metal halide materials now known in the art or hereafter developed for reversibly adsorbing pi-complex bonded compounds (such as for example carbon monoxide and unsaturated hydrocarbons), which can then subsequently be desorbed by lowering the partial pressure of the target gas or by increasing the temperature of the adsorbent. Such suitable active metal compounds may include copper(I) chloride.

Suitable metal halide compounds may be dispersed on a suitable precursor adsorbent material, such as activated carbon, to provide a loading range effective to reduce or substantially eliminate carbon monoxide and/or unsaturated hydrocarbons in a feed stream. This effective loading range typically is between from about 5 to about 55% by weight of the mixture on a dry basis, and more typically between from about 15 to about 45% by weight. A desired effective loading may be selected for a specific application taking into account the concentration of carbon monoxide and/or unsaturated hydrocarbons desired to be adsorbed from a specific feed gas mixture, relative to other gas (or vapor) species desired to be adsorbed by the inventive modified adsorbent material, such as carbon dioxide, nitrogen, methane, and water. For use of improved adsorbent materials according to the present invention, increased metal halide loading on the activated carbon adsorbent material may increase the ultimate adsorptive capacity of the inventive adsorbent for carbon monoxide and/or unsaturated hydrocarbons, while decreasing the ultimate adsorptive capacity of the inventive adsorbent for other gas species such as carbon dioxide, nitrogen, methane, and water.

An improved adsorbent material selective for carbon monoxide and/or unsaturated hydrocarbons according to the present invention may be produced by dispersing a suitable metal halide compound on the surface of a suitable activated carbon adsorbent material by means of thermal dispersion. According to an exemplary embodiment of the invention, both the metal halide compound and the precursor activated support, such as carbon adsorbent material, preferably may be prepared in fine powder form typically having mean particle diameters of less than about 100 microns, and perhaps less than about 90 microns. Such metal halide and activated support powders may be intimately and substantially evenly mixed and heated, most typically in an inert atmosphere (such as nitrogen, argon, or CO₂) to a temperature and for a period of time sufficient to thermally disperse the metal halide substantially evenly on the surface of the activated carbon adsorbent. Such heating may be to a temperature ranging between from about 100° C. to about 350° C. and such period of time typically may range between about 1 hour to about 72 hours.

In view of the many possible embodiments to which the principles of this disclosure may be applied, it should be recognized that the illustrated embodiments are only preferred examples and should not be taken as limiting the scope of the invention.

We claim:

1. An adsorbent material which is adsorptively selective for carbon monoxide, unsaturated hydrocarbons, or mixtures thereof, wherein the adsorptive working capacity of the adsorbent material at partial pressures of carbon monoxide, unsaturated hydrocarbons, or mixtures thereof above 0.2 bar is at least about 0.6 mmol/g·bar, as measured for adsorption of carbon monoxide at about 70° C.

2. The adsorbent material according to claim 1 wherein the adsorptive working capacity of the adsorbent material at partial pressures of carbon monoxide, unsaturated hydrocarbons, or mixtures thereof above 0.2 bar is at least about 0.75 mmol/g·bar, as measured for adsorption of carbon monoxide at about 70° C.

3. The adsorbent material according to claim 1 comprising copper, silver, tin, or combinations thereof.

4. The adsorbent material according to claim 3 comprising a copper halide, a silver nitrate, a tin oxide, or combinations thereof.

5. The adsorbent material according to claim 1 where the adsorbent material comprises a metal halide compound and an activated adsorbent.

6. The adsorbent material according to claim 5 where the metal halide compound is thermally dispersed or aqueously impregnated on the surface of an activated carbon adsorbent.

7. The adsorbent material according to claim 5 where the metal halide compound comprises CuCl.

8. The adsorbent material according to claim 7 where the CuCl is dispersed on an activated carbon adsorbent at a loading of from about 5% to about 55% by weight of the mixture on a dry basis.

9. The adsorbent material according to claim 7 where the CuCl is dispersed on the surface of the activated carbon adsorbent at a loading of from about 15% to about 45% by weight of the mixture on a dry basis.

10. The adsorbent material according to claim 5 where the activated adsorbent material is activated carbon having a mean pore diameter of from about 7 Angstroms to about 550 Angstroms.

11. The adsorbent material according to claim 2 where the adsorbent material comprises a metal halide compound and an activated carbon adsorbent.

12. The adsorbent material according to claim 11 where the metal halide compound is thermally dispersed or aqueously impregnated on the surface of the activated carbon adsorbent.

13. The adsorbent material according to claim 11 where the metal halide compound comprises CuCl.

14. The adsorbent material according to claim 13 wherein the CuCl is dispersed on the surface of the activated carbon adsorbent at a loading of from about 5% to about 55% by weight of the mixture on a dry basis.

15. The adsorbent material according to claim 13 where the CuCl is dispersed on the surface of the activated carbon adsorbent at a loading of from about 15% to about 45% by weight of the mixture on a dry basis.

16. The adsorbent material according to claim 13 where the activated carbon adsorbent material has a mean pore diameter of from about 7 Angstroms to about 550 Angstroms.

17. An adsorbent material having an adsorptive selectivity for carbon monoxide, unsaturated hydrocarbons or mixtures thereof relative to other gas species, comprising an activated adsorbent material and a metal halide, nitrate or oxide compound deposited on the surface of the activated adsorbent material, wherein the adsorptive selectivity of the adsorbent material for carbon monoxide, unsaturated hydrocarbons, or mixtures thereof relative to other gas species may be varied by controlling the amount of metal halide, nitrate or oxide compound deposited on the surface of the activated adsorbent material.

18. The adsorbent material according to claim 17 where the metal halide, nitrate or oxide compound is thermally dispersed or aqueously impregnated on the surface of an activated carbon adsorbent.

19. The adsorbent material according to claim 17 comprising copper, silver, tin, or combinations thereof.

20. The adsorbent material according to claim 19 comprising a copper halide, a silver nitrate, a tin oxide, or combinations thereof.

21. The adsorbent material according to claim 17 comprising CuCl.

22. The adsorbent material according to claim 17 where the activated adsorbent material is an activated carbon adsorbent material having a mean pore diameter of from about 7 Angstroms to about 550 Angstroms.

23. The adsorbent material according to claim 1 where the adsorbent material is a bead or a pellet.

24. The adsorbent material according to claim 17 where the adsorbent material is a bead or a pellet.

25. An adsorber element, comprising:
a support sheet; and
adsorbent material deposited on the sheet having an adsorptive working capacity at partial pressures of carbon monoxide, unsaturated hydrocarbons, or mixtures thereof above 0.2 bar of at least about 0.6 mmol/g·bar, as measured for adsorption of carbon monoxide at about 70° C.

26. The adsorber element according to claim 25 where the adsorbent material comprises an activated adsorbent material and a metal halide compound deposited on the surface of the activated adsorbent material, the adsorptive selectivity of the adsorbent material for carbon monoxide, unsaturated hydrocarbons, or mixtures thereof relative to other gas species being varied by controlling the amount of metal halide compound deposited on the surface of the activated adsorbent material.

27. The adsorber element according to claim 25 where the adsorbent material comprises copper, silver, tin, or combinations thereof.

28. The adsorber element according to claim 25 where the adsorbent material comprises a copper halide, a silver nitrate, a tin oxide, or combinations thereof.

29. The adsorber element according to claim 25 where the asborbernt material comprises a metal halide compound deposited on an activated carbon adsorbent.

30. The adsorber element material according to claim 29 where the metal halide compound comprises CuCl.

31. The adsorber element according to claim 25 where the adsorbent material comprises activated carbon adsorbent having a mean pore diameter of from about 7 Angstroms to about 550 Angstroms.

32. A method for selectively removing carbon monoxide, unsaturated hydrocarbons, or mixtures thereof, from a feed fluid, comprising:
providing an adsorbent material, or adsorber element comprising the adsorbent material, where the absorbent material is adsorptively selective for carbon monoxide, unsaturated hydrocarbons, or mixtures thereof, and where the adsorptive working capacity of the adsorbent material at partial pressures of carbon monoxide, unsaturated hydrocarbons, or mixtures thereof above 0.2 bar is at least about 0.6 mmol/g·bar, as measured for adsorption of carbon monoxide at about 70° C.; and
using the adsorbent material to selectively remove carbon monoxide, unsaturated hydrocarbons, or mixtures thereof, from a feed fluid comprising carbon monoxide, unsaturated hydrocarbons, or mixtures thereof.

33. The method according to claim 32 where the adsorbent comprises an activated adsorbent material and a metal halide compound deposited on the surface of the activated adsorbent material, the adsorptive selectivity of the adsorbent material for carbon monoxide, unsaturated hydrocarbons, or mixtures thereof relative to other gas species being varied by controlling the amount of metal halide compound deposited on the surface of the activated adsorbent material.

34. The method according to claim 32 where the adsorbent material comprises copper, silver, tin, or combinations thereof.

35. The method according to claim 32 where the adsorbent material comprises a copper halide, a silver nitrate, a tin oxide, or combinations thereof.

36. The method according to claim 32 where the asborbernt material comprises a metal halide compound deposited on an activated carbon adsorbent.

37. The method according to claim 36 where the metal halide compound comprises CuCl.

38. The method according to claim 37 where the activated carbon adsorbent material has a mean pore diameter of from about 7 Angstroms to about 550 Angstroms.
